(19) United States
(12) Patent Application Publication
(10) Pub. No.: US 2026/0218017 A1
(43) Pub. Date: Jul. 30, 2026

(54) ADDITIVES FOR CAUSTIC REMOVAL OF ADHESIVE FROM SUBSTRATES, HOT MELT ADHESIVES COMPRISING SUCH ADDITIVES, AND METHODS FOR RECYCLING LAMINATES BONDED BY SUCH ADHESIVES

(71) Applicant: Bostik SA, Puteaux (FR)

(72) Inventor: Nolan MITCHELL, Wauwatosa, WI (US)

(21) Appl. No.: 19/144,660

(22) PCT Filed: Dec. 22, 2023
(86) PCT No.: PCT/EP2023/087556

§ 371 Date: Jun. 30, 2025

(30) Foreign Application Priority Data
Dec. 29, 2022 (EP) 22307063.2
Dec. 30, 2022 (EP) 22307074.9
Feb. 20, 2023 (EP) 23305220.8

(51) Int. Cl. C09J 11/08; B32B 43/00; C08G 81/02; C09J 5/00; C09J 11/06; C09J 123/20; C09J 153/02

(52) U.S. Cl. CPC C09J 11/08; B32B 43/006; C08G 81/025; C09J 5/00; C09J 11/06; C09J 123/20; C09J 153/02

(57) ABSTRACT

An additive composition for facilitating delamination of hot melt adhesives from substrates comprises a polymer having the structure (I): (I) wherein: m is from about 35 to about 1,200; n is the number of moles of maleic anhydride in a reactant used to form the polymer and is from about 2 to about 1200; 1 is from about 1 to about 780; n−1 is from about 1 to about 420; y is from 0 to about 45; z is from 0 to about 33, provided that y or z is at least about 5; and the ratio of l:n is at most 0.65:1. The additive composition may further comprise an auxiliary agent, such as a fatty acid. A hot melt adhesive composition comprises th additive, a base polymer and optionally a tackifier and a plasticizer. Methods for recycling substrates comprise delaminating the adhesive from the substrates using a caustic wash.

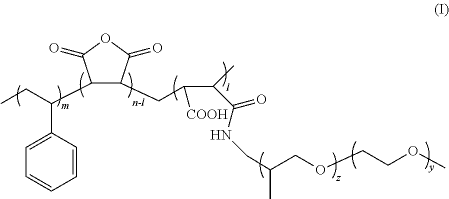

### FIELD OF THE INVENTION

This invention relates to additives for use in hot melt adhesives that facilitate delamination of such adhesives from substrates under a caustic wash without unduly impacting the adhesive properties of such adhesives, such as their peel strength. This invention further relates to the hot melt adhesive compositions including such additives and to methods for recycling substrates, including plastic, glass, and nonwoven substrates, bonded by such adhesives with other substrates, such as films or paper.

### BACKGROUND OF THE INVENTION

Hot melt adhesives typically exist as a solid mass at ambient temperature and can be converted to a flowable liquid by the application of heat. These adhesives are particularly useful in manufacturing a variety of disposable goods in which bonding of various substrates is often necessary. Specific applications include disposable diapers, hospital pads, feminine sanitary napkins, panty shields, surgical drapes and adult incontinent briefs, collectively known as disposable nonwoven hygienic products. Other diversified applications have involved paper products, packaging materials, automotive headliners, appliances, tapes and labels, including affixing labels to various surfaces, such as to glass or plastic containers. In most of these applications, the hot melt adhesive is heated to its molten state and then applied to a substrate, referred to as the primary substrate. A second substrate, referred to as the secondary substrate, is then immediately brought into contact with and compressed against the first substrate. The adhesive solidifies on cooling to form a strong bond. The major advantage of hot melt adhesives is the absence of a liquid carrier, which is present in waterborne or solvent-based adhesives, thereby eliminating the costly process associated with solvent removal.

In view of the impacts of the increasing rate of consumption of our planet's natural resources and growing pollution of our planet, there has been an increasing desire in the chemical industry to ensure sustainable consumption and production patterns. To foster such sustainable patterns, polymer end-of-life assessments are critical for efficient recycling into monomers, new products, or other non-landfill options. In many products, even though adhesives play a critical role, it is important to separate the adhesives from substrates to permit recycling of the substrates. The presence of adhesive still bonded to substrates being recycled would contaminate recycled products made from such substrates. Accordingly, this desire manifests itself in developing technologies that would permit easy and substantially complete delamination of adhesives from substrates. Such technologies would allow for separate recycling or reuse of the substrates. Efforts have been made to permit such separation and recycling.

U.S. Patent Publication No. 2016/0186023 describes the synthesis of certain additives which impart removability to hot melt adhesives from kraft paper, glass, and polyethylene terephthalate. The additives include a hydrocarbon copolymer containing one or more dicarboxylic acid moieties in at least partial ester form and a C5 hydrocarbon polymer having one or more pendant dicarboxylic acid moieties in at least partial ester form.

### SUMMARY OF THE INVENTION

There remains a need to improve the ease of delamination of hot melt adhesives from substrates using a caustic wash, which is used in recycling processes in many regions. While wash-off of adhesive in mild caustic solutions from polar substrates, such as glass and kraft paper, can be achieved relatively easily, there remains further needs to improve the ease of delamination from both polar and non-polar substrates, such as polyethylene terephthalate and polypropylene, from which removal is generally more difficult. It has been found that by utilizing an amide linkage, instead of an ester linkage, in polystyrene-polymaleic anhydride polymers facilitates such wash-off both from polar and non-polar substrates, and the addition of certain auxiliary agents, such as fatty acids, improves the wash-off from such substrates of adhesives containing these materials. Such ease of wash-off is achieved even without unduly reducing the adhesive properties (such as peel strength) of the adhesive.

In accordance with an embodiment of the present invention, an additive composition for facilitating delamination of a hot melt adhesive from a substrate comprises a polymer having the following structure (I):

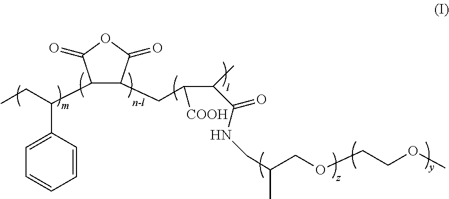

wherein: m is from about 35 to about 1,200, preferably from about 40 to about 750, and most preferably from about 45 to about 700; n is the number of moles of maleic anhydride in a reactant used to form the polymer and is from about 2 to about 1200, preferably about 4 to about 750, and most preferably from about 5 to about 300; l is from about 1 to about 780, preferably about 2 to about 450, and most preferably from about 3 to about 165; n-l is from about 1 to about 420, preferably about 2 to about 300, and most preferably from about 2 to about 135; y is from 0 to about 45, preferably about 3 to about 10, and most preferably from about 3 to about 9; z is from 0 to about 33, preferably about 10 to about 33, and most preferably from about 12 to about 30, provided that one of y or z is at least about 5; and the ratio of l:n is at most about 0.65:1, preferably at most about 0.6:1, and most preferably at most about 0.55:1. The additive composition may further comprise an auxiliary agent selected from the group consisting of a fatty acid dimer, a fatty acid, an ester of a fatty acid, and a metal carboxylate salt of a fatty acid, and combinations thereof.

In accordance with another embodiment of the invention, a hot melt adhesive composition comprises:
a base polymer;
a polymer having the following structure (I) (also referred to herein as an auxiliary polymer):

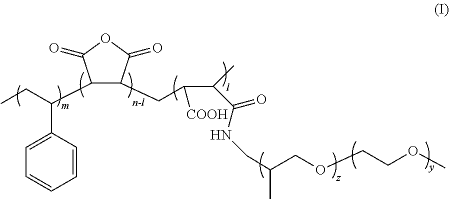

wherein: m is from about 35 to about 1,200, preferably from about 40 to about 750, and most preferably from about 45 to about 700; n is the number of moles of maleic anhydride in a reactant used to form the polymer and is from about 2 to about 1200, preferably about 4 to about 750, and most preferably from about 5 to about 300; l is from about 1 to about 780, preferably about 2 to about 450, and most preferably from about 3 to about 165; n-l is from about 1 to about 420, preferably about 2 to about 300, and most preferably from about 2 to about 135; y is from 0 to about 45, preferably about 3 to about 10, and most preferably from about 3 to about 9; z is from 0 to about 33, preferably about 10 to about 33, and most preferably from about 12 to about 30, provided that one of y or z is at least about 5; and the ratio of l:n is at most about 0.65:1, preferably at most about 0.6:1, and most preferably at most about 0.55:1;
optionally, an auxiliary agent selected from the group consisting of a fatty acid dimer, a fatty acid, an ester of a fatty acid, and a metal carboxylate salt of a fatty acid, and combinations thereof;
optionally, a tackifier; and
optionally, a plasticizer.

In accordance with another embodiment of the invention, a method for recycling a first substrate and a second substrate of a laminate bonded by a hot melt adhesive according to embodiments of the invention described herein, comprises the steps of:
contacting the laminate with a recycling solution having a pH sufficient to delaminate the adhesive from at least one of the first substrate and the second substrate; and
retrieving from the recycling solution the at least one of the first substrate and the second substrate free from the adhesive.

Embodiments of the invention also include a laminate formed by bonding two substrates using a hot melt adhesive composition of embodiments of the invention, such as a plastic or glass container (e.g., bottles or trays) having a label bonded thereto or a nonwoven substrate bonded to a polymeric film (e.g., a polyethylene back sheet), for example that could serve as a component in a disposable nonwoven hygienic product, such as a disposable diaper.

### DETAILED DESCRIPTION OF THE INVENTION

An embodiment of the invention is directed to an additive composition for facilitating delamination of a hot melt adhesive from a substrate. As such, the additive composition renders the bonded hot melt adhesive formed from the hot melt adhesive composition containing the additive composition to be more readily removed from a substrate under a given set of conditions, such as upon exposure to a caustic wash at a given temperature. The caustic wash as described herein is an aqueous solution of a base (such as an inorganic base or an organic base), as is typically used in the recycling industry. Other components of the caustic wash may include, but are not limited to, surfactants and defoamers. In an exemplary embodiment, the pH of the caustic wash is basic (i.e., has a pH greater than 7). In an exemplary embodiment, the pH is greater than 7 and less than 13, such as greater than 7 and less than 12, greater than 7 and less than 11, greater than 7 and less than 10, or greater than 7 and less than 9.

The substrates with which the additive composition described herein may be used vary over a wide range, including both polar and non-polar substrates. Such substrates include glass, plastic, polymeric material (including PET, polyethylene, polypropylene, polystyrene), wood, coated substrates, metal, and nonwoven substrates. In an embodiment, the substrates bonded by a hot melt adhesive comprising the additive composition described herein form a laminate to be used as a component in a disposable nonwoven hygienic product, such as a disposable diaper, and are a nonwoven substrate and a polyethylene back sheet, including a treated polyethylene back sheet. In another embodiment, the substrates bonded by a hot melt adhesive comprising the additive composition described herein form a laminate comprising a label bonded to a glass or plastic container, such as a beverage container or a food tray. One particular laminate suitable for use with the present is a film of oriented polypropylene (OPP) bonded to plastic containers made of polyethylene terephthalate and/or high density polyethylene, the materials used for bottles of beverages, such as water and soft drinks.

In an embodiment of the invention, the additive composition comprises a polymer having the following structure (I):

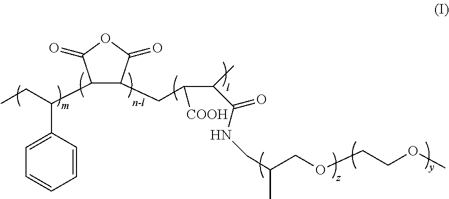

wherein: m is from about 35 to about 1,200, preferably from about 40 to about 750, and most preferably from about 45 to about 700; n is the number of moles of maleic anhydride in a reactant used to form the polymer and is from about 2 to about 1200, preferably about 4 to about 750, and most preferably from about 5 to about 300; l is from about 1 to about 780, preferably about 2 to about 450, and most preferably from about 3 to about 165; n-l is from about 1 to about 420, preferably about 2 to about 300, and most preferably from about 2 to about 135; y is from 0 to about 45, preferably about 3 to about 10, and most preferably from about 3 to about 9; z is from 0 to about 33, preferably about 10 to about 33, and most preferably from about 12 to about 30, provided that one of y or z is at least about 5; and the ratio of l:n is at most about 0.65:1, preferably at most about 0.6:1, and most preferably at most about 0.55:1. In an embodiment of the invention, the polymer has a weight average molecular weight of about 1,000 and about 250,000 daltons, preferably about 5,000 and about 100,000.

The reactant used to form the polymer shown in structure (I) may be any suitable styrene maleic anhydride copolymer and can be either a random or block copolymer. Although other reactants are used to form the polymer, reference to ‘n’ in structure (I) are intended to refer to the reactant having both styrene and maleic anhydride residues. As used herein, the term “residue” (also referred to herein as a polymerized product) shall mean the product of a reactant, such as the moiety remaining from a monomer in a polymer or from a polymer in a block copolymer. One such reactant is a non-modified, random styrene maleic anhydride (SMA) copolymer commercially available from Polyscope and sold under the trademark XIRAN® 3000.

To form the polymer of structure (I) the SMA reactant is reacted with an amine-terminated polyether. Preferably, the amine-terminated polyether comprises residues of propylene glycol solely (y of structure I above is zero), ethylene glycol solely (z of structure I above is zero), or both propylene glycol and ethylene glycol. In embodiments of the invention, the ratio of y:z is between about 0 and 1:1. This residue is depicted in structure (I) as the ligand extending from the amide linkage to the propylene and ethylene blocks and their terminus (such as a methyl group as shown in structure (I)). Although the amide linkage is shown in structure (I) as bonded to a propylene glycol residue, the amide linkage may be bonded directly to an ethylene glycol residue. Similarly, the terminus may be at either an ethylene glycol residue or a propylene glycol residue. In addition, the structure of the amine-terminated polyether may be a random copolymer or a block copolymer. In embodiments, the amine-terminated polyether is a mono-functional amine and is one of the products that are sold under the trademark JEFFAMINE® polyether amines by Huntsman, such as JEFFAMINE® M-600, M-1000, and M-2005 polyetheramines. The weight average molecular weights of these amine-terminated polyethers may vary over a wide range, such as between about 250 g/mol to about 25,000 g/mol, preferably between about 400 g/mol to about 15,000 g/mol.

An exemplary embodiment of a process for producing a polymer of structure (I) comprises adding a commercially available styrene-maleic anhydride (SMA) copolymer to a reactor that is precharged with an approximately stoichiometric amount of an amine-terminated polyether for a partial amidization of the SMA reactant while heating to a temperature of at least about 150° C. (preferably about 200° C.) under nitrogen and held at that temperature until the reaction level reaches equilibrium, as measured by any suitable analytical method, such as NMR or FTIR. Once equilibrium is reached, then the product is cooled and removed from the reactor. This reaction is shown below in scheme (II), with the “Additive” shown below referring to the amine-terminated polyether:

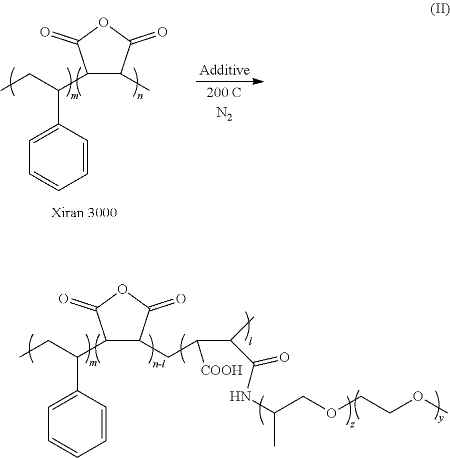

As can be appreciated from the above, n represents the number of moles of maleic anhydride in this reactant and m represents the number of moles of styrene in this reactant. Although the number of moles of styrene (‘m’) in the material does not change during the reaction, the number of moles of maleic anhydride (n) is reduced by ‘l,’ which corresponds to the number of moles of amide-linked polyether that are formed. As shown in structure (I), ‘n-l’ represents the remainder of the unreacted maleic anhydride species and ‘l’ represents the moles of maleic anhydride which react to form carboxylic acid with the branched amide-linked polyether. Thus, in a compound in which n equals 1, all of the maleic anhydride present in the SMA reactant have reacted to form carboxylic acid and the amide-linked polyether.

In embodiments of the invention, the ratio of m:n is between about 1:1 and 25:1. This is determined by the nature of the starting SMA reactant. In other embodiments of the invention, the ratio of l:n is at most about 0.65:1, preferably at most about 0.6:1, and most preferably at most about 0.55:1. In embodiments, the ratio of l:n is between about 1:10 to about 0.65:1, preferably between about 1:4 and 0.6:1. In other words, the number of moles of maleic anhydride in the reactant (n) is well in stoichiometric excess relative to number of moles of amide-linked polyether (1). This is determined by the relative amounts of the SMA reactant and the amine-terminated polyether present in scheme (II).

According to an embodiment of the invention, m is from about 35 to about 700; n is the number of moles of maleic anhydride in a reactant used to form the polymer and is from about 9 to about 40; l is from about 6 to about 26; n-l is from about 3 to about 34; y is from 0 to about 45; z is from 0 to about 33, provided that one of y or z is at least about 5; and the ratio of l:n is at most about 0.65:1.

According to embodiments of the invention, the additive composition further comprises an auxiliary agent selected from the group consisting of a fatty acid dimer, a fatty acid, an ester of a fatty acid, and a metal carboxylate salt of a fatty acid, and combinations thereof. Fatty acids are carboxylic acids with an aliphatic chain, which is either saturated or unsaturated. Fatty acid dimers (also known as dimerized fatty acids) are dicarboxylic acids produced by dimerizing unsaturated fatty acids including those obtained from tall oil, oleic acid, canola oil, or cottonseed oil. In a preferred embodiment, the auxiliary agent is a fatty acid dimer commercially available under the trademark Radiacid 970 sold by Oleon. The metal of the metal carboxylate salt may be selected from the group consisting of Group I or II metals and preferably is zinc, magnesium, or calcium. The auxiliary agent may be selected from the group consisting of zinc stearate, methyl stearate, and castor oil. In embodiments of the invention, the weight ratio of the polymer to the auxiliary agent is between about 2:1 and about 5:1, preferably between about 5:2 and about 4:1.

It has been found that, in some embodiments, the inclusion of the auxiliary agent has unexpectedly improved the ease of wash-off of a hot melt adhesive containing it, both in terms of its extent of wash-off and by allowing for the adhesive mode of failure upon wash-off. In one embodiment, as soon as wash-off is complete from one of the substrates, the substrate from which the adhesive has delaminated is removed from the recycling solution (also referred to as the caustic wash) to reduce the time of recycling. In some embodiments, adhesive, as opposed to cohesive, is the preferred mode of failure. If recycling a laminate having an adhesive that undergoes adhesive failure upon wash-off, it is possible to reduce the overall wash-off time by removing the substrates now free of adhesive from the recycling solution. In some embodiments, the second substrate still having adhesive bonded thereto is simply discarded or is further processed with a caustic wash, possibly under more rigorous conditions, to delaminate the adhesive therefrom. For example, in a case of a plastic bottle with an OPP label, the adhesive would preferably undergo adhesive failure from the plastic bottle to permit that substrate to undergo a less rigorous caustic wash, before being recycled or reused, than it otherwise would have required in the absence of the additive composition of the present invention.

According to an embodiment of the present invention, a hot melt adhesive composition comprises a base polymer; an auxiliary polymer (which is the same as the polymer of structure (I) as described above); optionally, an auxiliary agent selected from the group consisting of a fatty acid dimer, a fatty acid, an ester of a fatty acid, and a metal carboxylate salt of a fatty acid, and combinations thereof; optionally, a tackifier; and optionally, a plasticizer.

As used herein, the base polymer may be any known polymer that provides cohesive force to the adhesive. Such base polymers are well-known in the art and may be selected from the group consisting of a styrene block copolymer, polyethylene vinyl acetate (EVA) resins, polyolefins, amorphous poly-α olefin (APAO) resins, and mixtures thereof. In an embodiment of the invention, the base polymer is a styrene block copolymer, and the styrene block copolymer is selected from the group consisting of styrene-isoprene-styrene (SIS), styrene-butadiene-styrene (SBS), styrene-isoprene-butadiene-styrene (SIBS), styrene-ethylene-propylene-styrene (SEPS), styrene-ethylene-butylene-styrene (SEBS) block copolymers, and combinations thereof, preferably SIS. Such styrene block copolymers are commercially available under the trademark KRATON™ from Kraton Corporation. One suitable SIS block copolymer is sold under the trademark KRATON™ D-1113, which has 16% styrene and 55% diblock.

In embodiments of the invention, the hot melt adhesive comprises the auxiliary agent, a tackifier, and/or a plasticizer. If a tackifier (also referred to as a tackifying resin) is used, it may be selected from one or more of the following:
aliphatic and cycloaliphatic petroleum hydrocarbon resins having Ring and Ball (R&B) softening points of from 10° C. to 150° C., as determined by ASTM method E28-58T, the latter resins resulting from the polymerization of monomers consisting primarily of aliphatic and/or cycloaliphatic olefins and diolefins;
hydrogenated aliphatic and cycloaliphatic petroleum hydrocarbon resins, examples of such commercially available resins based on a C5 olefin fraction of this type are Piccotac 95 and Escorez 1310LC tackifying resins sold by Eastman Chemicals and Wingtack ET tackifying resin sold by Cray Valley, and examples of hydrogenated cycloaliphatic petroleum hydrocarbon resins based on cyclopentadiene are Escorez 5400 from ExxonMobil and Resinall R1095S from Resinall Corporation;
aromatic petroleum hydrocarbon resins and the hydrogenated derivatives thereof, an example of hydrogenated aromatic hydrocarbon resin is Arkon P-115 from Arakawa Chemicals;
aliphatic/aromatic petroleum derived hydrocarbon resins and the hydrogenated derivatives thereof;
aromatic modified cycloaliphatic resins and the hydrogenated derivatives thereof;
polyterpene resins having a softening point of from about 10° C. to about 140° C., the latter polyterpene resins generally resulting from the polymerization of terpene hydrocarbons, such as the mono-terpene known as pinene, in the presence of Friedel-Crafts catalysts at moderately low temperatures;
hydrogenated polyterpene resins;
copolymers and terpolymers of natural terpenes, e.g. styrene/terpene, ethyl styrene/terpene and vinyl toluene/terpene;
natural and modified rosin such as, for example, gum rosin, wood rosin, tall-oil rosin, distilled rosin, hydrogenated rosin, dimerized rosin and polymerized rosin;
glycerol and pentaerythritol esters of natural and modified rosin, such as, for example, the glycerol ester of pale wood rosin, the glycerol ester of hydrogenated rosin, the glycerol ester of polymerized rosin, the pentaerythritol ester of pale wood rosin, the pentaerythritol ester of hydrogenated rosin, the pentaerythritol ester of tall-oil rosin, and the phenolic modified pentaerythritol ester of rosin; and
phenolic-modified terpene resins such as, for example, the resin product resulting from the condensation in an acidic medium of a terpene and a phenol.

Mixtures of two or more of the above described tackifying resins may be required for some formulations. Tackifying resins which are useful for the present invention can include polar tackifying resins. Preferably, the tackifying resins can be selected from any of the nonpolar types, which are commercially available. Preferred resins for use herein are thermoplastic resins obtained from the copolymerization and hydrogenation of C5 aliphatic olefin and diolefin generated in the thermal cracking process of naphtha. Examples of such resins include the SUKOREZ® line of resins commercially available from Kolon Industries.

In embodiments of the invention, the hot melt adhesive composition also comprises a plasticizer. A plasticizer serves to provide desired viscosity control and to impart flexibility. A suitable plasticizer may be selected from the group which includes the usual plasticizing oils, such as mineral oil, but also olefin oligomers and low molecular weight polymers, as well as vegetable and animal oils and derivatives thereof. The petroleum derived oils which may be employed are relatively high boiling materials containing only a minor proportion of aromatic hydrocarbons. In this regard, the aromatic hydrocarbons should preferably be less than 30% and more particularly less than 15% of the oil, as measured by the fraction of aromatic carbon atoms. More preferably, the oil may be essentially non-aromatic. The oligomers may be polypropylenes, polybutenes, hydrogenated polyisoprenes, hydrogenated polybutadienes, or the like having average molecular weight between about 350 g/mole and about 10,000 g/mole. Suitable vegetable and animal oils include glycerol esters of the usual fatty acids and polymerization products thereof. Other useful plasticizers can be found in the families of conventional dibenzoate, phosphate, phthalate esters, as well as esters of mono- or polyglycols. Examples of such plasticizers includes, but are not limited to dipropylene glycol dibenzoate, pentaerythritol tetrabenzoate, 2-ethylhexyl diphenyl phosphate, polyethylene glycol 400-di-2-ethylhexoate; butyl benzyl phthalate, dibutyl phthalate and dioctylphthalate. As will be appreciated, plasticizers have typically been used to lower the viscosity of the overall adhesive composition without substantially decreasing the adhesive strength and/or the service temperature of the adhesive as well as to extend the open time and to improve flexibility of the adhesive. Suitable plasticizers for use herein include the CALSOL line of plasticizers, commercially available from Calumet Specialty Products, and naphthenic oil sold under the trademark NYFLEX.

The hot melt adhesive composition may further comprise a stabilizer or antioxidant. If used, an antioxidant, such as a hindered phenol, is present in an amount effective to prevent oxidation or stabilize the adhesive and in embodiments is present in an amount of between about the anti-oxidant is present in an amount of between about 0.1 and about 1% by weight, preferably between about 0.25 and about 0.75% by weight, and most preferably between about 0.4 and about 0.6% by weight.

It should be understood that other optional additives may be incorporated into the hot melt adhesive composition of the present invention in order to modify particular physical properties. These optional additives may include, for example, such materials as inert colorants e.g. titanium dioxide, fillers, fluorescent agents, UV absorbers, surfactants, and other types of polymers. Typical fillers include talc, calcium carbonate, clay silica, mica, wollastonite, feldspar, aluminum silicate, alumina, hydrated alumina, glass microspheres, ceramic microspheres, thermoplastic microspheres, baryte and wood flour. Surfactants are particularly important in hygienic disposable nonwoven because they can dramatically reduce the surface tension, for example, of the adhesive applied to diaper core, thereby permitting quicker transport and subsequent absorption of urine by the core.

The relative amounts of the constituents of the hot melt adhesive composition of the present invention can vary over a wide range depending on the particular end use and desired properties, including the adhesive properties, desired mode of failure (if any), application temperature, viscosity at the application temperature, shore A hardness, perceived softness, and desired wash-off properties, including the extent of wash-off in a caustic wash. In an embodiment of the invention, the base polymer, the auxiliary polymer, the auxiliary agent, the tackifier, and the plasticizer are present in amounts effective to: (1) provide an average 90° peel strength of mylar-to-glass of at least about 1,000 grams-force, preferably at least about 1,500 grams-force; (2) provide at least 80%, preferably 100%, wash-off from mylar-to-glass; and (3) undergo adhesive failure.

In order to determine the average 90° peel strength of an adhesive, the adhesive is coated to the first-listed substrate listed herein at a thickness of 1 mil by hand draw-downs on a heated table. As used herein, the first-listed substrate in the laminates mentioned herein may be referred to as ‘Substrate 1’ with the second-listed substrate being referred to as ‘Substrate 2.’ For example, Mylar® polyester is Substrate 1 and glass is Substrate 2 in the ‘Mylar-to-glass’ laminate. A silicone-based release liner was placed on top of Substrate 1 and the coating was given 24 h to cool and reach equilibrium. After 24 h, the laminate was cut into 6 in×1 in strips, the release liner was removed, the strip was applied to Substrate 2 and rolled 4 times with a 4 kg roller (Chem Instruments HR-100) to simulate pressure-sensitive application. After 24 hours of the adhesive bonded between Substrate 1 and Substrate 2, the laminates are pulled apart by the Chem Instrument Probe Material Analyzer at a rate of 12 inches per minute for 5 inches of distance. The peel force was measured in grams-force, and the peel value was calculated by determining the average peel strength after eliminating the first and last five percent of the sample length to reduce variability from starting and stopping the test. An example of Substrate one was a commercially available 0.002 mil TransPET (polyethyleneterephthalate) Oriented CAD2 Chem Treat 2 Sides (Transcendia) and example of Substrate 2 was a glass plate (Chem Instruments, meeting required ASTM D3330).

In order to determine the percentage wash-off, laminates were prepared in the same manner as discussed above, with the exception of Substrate 1 being biaxially oriented polypropylene (Taghleef LSA, 25 μm) as a possibility in addition to the previously stated Substrate 1, and Substrate 2 may be a glass substrate purchased from Chem Instruments in addition to PET and Kraft Paper (Uline, S3574). Once the laminates are made, they are given 24 hour to equilibrate and placed in a one liter beaker that is filled to 800 mL with a 2.5% sodium hydroxide (NaOH) solution and heated to 80° C. with 350 RPM of stirring using a magnetic stir bar coated in Teflon. The laminates are left in the caustic wash solution for 5 minutes, removed from the beaker, dried gently with a towel and evaluated for wash-off by a 0-5 scale or separation of the two substrates. The scale ranging in 20% for each number, e.g., 0 is 0% wash-off of the strip, 1 is 20%, advancing to 5 being 100% wash-off.

In order to determine the mode of failure, a visual study of the laminates subjected to the above wash-off conditions was performed after drying the laminates and after evaluating the wash-off. Laminates with adhesive solely maintaining bonding to Substrate 1 are considered adhesive failure. Cohesive failure was determined if the adhesive transferred to Substrate 2 during wash-off conditions and a combination of adhesive and cohesive failure is possible for the laminates

In another embodiment of the invention, the primary constituents of the hot melt adhesive composition are present in the following amounts:
the base polymer is present in an amount of between about 15 wt % and about 50 wt %, preferably between about 25 wt % and about 45 wt %;
the auxiliary polymer is present in an amount of between about 1 wt % and about 15 wt %, preferably between about 2 wt % and about 13 wt %;
the auxiliary agent is present in an amount of between about 0.5 wt % and about 10 wt %, preferably between about 1 wt % and about 5 wt %;
the tackifier is present in an amount of between about 20 wt % and about 60 wt %, preferably between about 30 wt % and about 50 wt %; and
the plasticizer is present in an amount of between about 2 wt % and about 20 wt %, preferably between about 4 wt % and about 15 wt %.

The amounts of the constituents stated herein are based on the total weight of the hot melt adhesive composition. The composition could be made up solely of (i.e., consist essentially of or consist of) the five primary constituents listed above, or the four constituents listed above other than the auxiliary agent. Alternatively, the hot melt adhesive composition may include one or more additional, optional constituents as mentioned above. As mentioned in the examples, the hot melt adhesive composition may further comprise a C5 hydrocarbon polymer comprising a polymeric backbone and, pendent thereon, one or more dicarboxylic acid moieties in at least partial ester form, such as a product produced from Wingtack 10, commercially available from Cray Valley, in accordance with the scheme (III) below. This ingredient was used in U.S. Publication No. 2016/0186023 and was not found to have a significant impact on the adhesive or wash-off performance of the hot melt adhesive. The product of scheme III is referred to as 1900-144 in the Examples below, produced from Wingtack 10 and maleic anhydride.

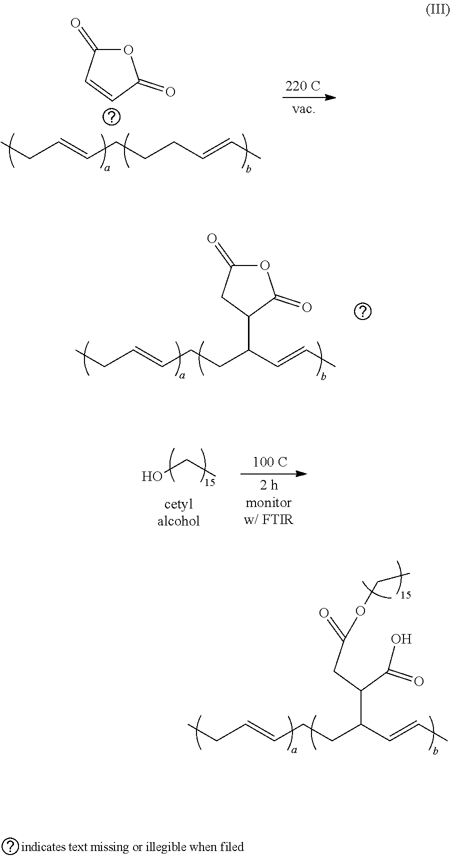

The viscosity of the adhesive material according to the present invention should be generally at a viscosity at the application temperature appropriate to be processed and applied to its substrate as a hot melt adhesive. An adhesive with relatively low viscosity at a low application temperature is needed to be processed through standard hot melt adhesive equipment and to achieve the desired pattern and consequently suitable bonding performance at the application temperature. In general, the viscosity is equal to or less than about 50,000 cP at application temperature, preferably equal to or less than about 40,000 cP at application temperature, even more preferably less than about 35,000 cP at application temperature, still more preferably less than about 30,000 cP at application temperature according to per ASTM-D3236 by using a Brookfield viscometer at, for example, 177° C. All viscosities identified herein are measured according to this modified ASTM standard. Preferably, the viscosity of the composition is at least 1,000 cP, more preferably at least 5,000 cP, still more preferably at least about 7,500 cP and most preferably at least about 15,000 cP, at application temperature. Thus the viscosity could be between 1,000 cP and 35,000 cP and between 5,000 cP and 20,000 cP at 121° C. In other embodiments, the viscosity of the composition is between any of the ranges contemplated herein at various typically used application temperatures, the value of which depends on the particular application of the adhesive, between 121° C. at 180° C., such as at 121° C., 127° C., 135° C., 149° C. and 177° C. In an embodiment in which the adhesive is used to bond a label to a glass or plastic container, the viscosity of the adhesive at 177° C. is preferably between about 5,000 cP and about 50,000 cP, more preferably between about 15,000 cP and about 35,000 cP, and most preferably between about 20,000 cP and about 30,000 cP, depending on a number of known parameters including the requirements of the processing and application equipment.

There is no particular order in making an adhesive composition of the present invention, and it may be made using conventional process steps. The adhesive may be made by mixing the various constituents and then heating just before application to a substrate. In one embodiment, the additive is first made, such as by making either the polymer of structure (I) and mixing that with the other adhesive ingredients, or making the additive composition comprising the polymer of structure (I) and the auxiliary agent and mixing that additive composition with the other adhesive ingredients. Also, the two ingredients of the additive could be added separately to the other ingredients. For example, in one embodiment, the oil, anti-oxidant, tackifier, auxiliary polymer, and auxiliary agent are combined and melted, then the base polymer is added to and blended with that melt. In addition, the SMA reactant and amine-terminated polyether could be reacted in the presence of at least some of the other constituents of the hot melt adhesive. For example, in one embodiment (referred to as the ‘in situ’ method), the SMA reactant and the base polymer are melted and blended together, then the amine-terminated polyether, the plasticizer, the tackifier, and the anti-oxidant are added sequentially to this melt, then finally the auxiliary agent is added thereto. Regardless of the order of addition, it has been found that the hot melt adhesive composition contains a base polymer, a polymer of structure (I), an auxiliary agent (when used), a tackifier (when used), a plasticizer (when used), and an anti-oxidant (when used). Additional side reaction products may be present in certain embodiments (most likely in the in situ method), but these side reaction products have not been found to materially adversely affect the adhesive properties or wash-off performance of the adhesive. The in situ method serves to reduce process steps and saves resources.

More specifically, the mixing procedure of making the hot melt adhesive involves placing the components, such as in the order specified above, in a jacketed mixing kettle equipped with a rotor, and thereafter raising the temperature of the mixture to a range from 150° C. to 200° C. to melt the contents. The precise temperature used in these steps would depend on the melting points of the particular ingredients. Subsequently introduced materials are added to the kettle under agitation and the mixing is allowed to continue until a consistent and uniform mixture is formed. The content of the kettle may be protected with inert gas such as carbon dioxide or nitrogen during the entire mixing process. Without violating the spirit of the present invention, various additions and variation can be made to this procedure to produce the hot melt composition, such as, for example, applying vacuum to facilitate the removal of entrapped air. Other equipment useful for formulating the compositions of the present invention includes, but is not limited to, single or twin screw extruders or other variations of extrusion machinery, kneaders, intensive mixers, Ross™ mixers, and the like.

The adhesive composition of the present invention may be used as a general purpose hot melt adhesive in a number of applications such as, for example, in disposable nonwoven hygienic articles, labels for plastic or glass containers (such as beverage bottles and food trays), paper converting, flexible packaging, wood working, carton and case sealing, labeling and other assembly applications. Particularly preferred applications include nonwoven disposable diaper and feminine sanitary napkin construction, diaper and adult incontinent brief elastic attachment, diaper and napkin core stabilization, diaper backsheet lamination, industrial filter material conversion, and surgical gown and surgical drape assembly.

The resulting hot melt adhesives may be then applied to substrates using a variety application techniques. Examples includes hot melt glue gun, hot melt slot-die coating, hot melt wheel coating, hot melt roller coating, melt blown coating, spiral spray, contact or noncontact strand coatings branded as Omega™, Surewrap™, V-Slot™ and Allegro™ methods and the like. It is not the intent of this invention to provide a full description of various application techniques.

In an embodiment of the invention, a method of making a laminate comprises the steps of: (1) applying the hot melt adhesive composition of the invention in a molten state to a primary substrate; and (2) mating a secondary substrate to the first substrate by contacting the secondary substrate with the adhesive composition. The primary substrate may be a polyethylene back sheet to be used in a diaper laminate or a plastic or glass container, and the secondary substrate may comprise, respectively a nonwoven material or a paper or OPP label, or vice versa. A laminate made by any of the methods described herein may be used as a component in a disposable nonwoven hygienic product or a label adhered to a glass or plastic container, such as a beverage bottle or a food tray.

The recycling solution described herein causes release (delamination) of the hot melt adhesives from the substrates to which they are bonded, resulting in effective recycling of the substrate. As used herein, delamination contemplates that at least some of the adhesive is removed from the substrate to which it is attached. The extent of delamination is preferably complete and total but a partial release or partial delamination of the adhesive from the substrate under given recycling conditions may also represent an acceptable or satisfactory outcome. An additive composition which serves to facilitate delamination a hot melt adhesive from a substrate makes delamination easier than it would have been in the absence of such additive composition under the same recycling conditions.

In an exemplary embodiment, the recycling solution is an aqueous solution of a base (such as an inorganic base or an organic base). Other components may include, but are not limited to, surfactants and defoamers. The amount of the recycling/soaking solution used to effect release (delamination) of the bonded hot melt adhesive is not particularly limited and may be present in a large excess.

In an exemplary embodiment, the pH of the recycling solution or soaking solution is basic—i.e., has a pH greater than 7. In an exemplary embodiment, the pH is greater than 7 and less than 13, such as greater than 7 and less than 12, such as greater than 7 and less than 11, such as greater than 7 and less than 10, such as greater than 7 and less than 9.

A method for recycling at least one of a first substrate and a second substrate of a laminate bonded by a hot melt adhesive comprising the additive composition of the invention comprises the steps of: contacting the laminate with a recycling solution having a pH sufficient to delaminate the adhesive from at least one of the first substrate and the second substrate; and retrieving from the recycling solution the at least one of the first substrate and the second substrate free from the adhesive. In an embodiment, the substrates are first mechanically removed from one another. If the mode of failure during such removal is adhesive, then it is possible that one of the two substrates would not have any (or much) adhesive bonded thereto, in which case that substrate my only require less rigorous wash-off conditions or not need them at all.

The recycling solution may be a caustic wash, including a base. Suitable bases for inclusion in the recycling solution are not particularly limited and include inorganic bases and organic bases. Suitable inorganic bases include alkali metal and alkaline earth metal bicarbonates or carbonates (e.g., sodium bicarbonate, potassium bicarbonate, sodium carbonate, potassium carbonate, calcium bicarbonate, calcium carbonate). Inorganic bases such as alkali metal and alkaline earth metal hydroxides (e.g., sodium hydroxide, potassium hydroxide, calcium hydroxide) may also be used in some embodiments but are typically more caustic. Suitable organic bases include ammonia, pyridine and amines (e.g., isopropylamine, trimethylamine, diethylamine, triethylamine, tripropylamine, diethanolamine, ethanolamine, 2-dimethylaminoethanol, 2-diethylaminoethanol, dicyclohexylamine, etc.).

The temperature of the recycling solution may vary over a wide range based on a number of factors, including the desired wash-off time, given that washing off of the adhesive is facilitated at higher temperatures. The additive compositions of the present invention do not require wash-off temperatures at or above the crossover temperature of the hot melt adhesive being washed off of a substrate. Therefore, the wash-off temperature may be at least ambient temperature up to the adhesive's crossover temperature (Tx), or at least 10° C., 20° C., 30° C., or 40° C. below the crossover temperature. For example, in an embodiment in which the crossover temperature of the adhesive is 110° C., the wash-off temperature may be between about ambient to 80° C., preferably between about 50° C. to about 75° C. The Tx is defined as the highest temperature at which the storage modulus, G′, and loss modulus, G″, intersect as measured using dynamic mechanical analysis (DMA) of the adhesive while cooled from the molten to solid state. The test method used is ASTM D 4440-01, with a cooling rate of 10° C./min.

### ASPECTS OF THE INVENTION

The following describe various aspects of the invention
Aspect 1. An additive composition for facilitating delamination of a hot melt adhesive from a substrate, comprising a polymer having the following structure (I):

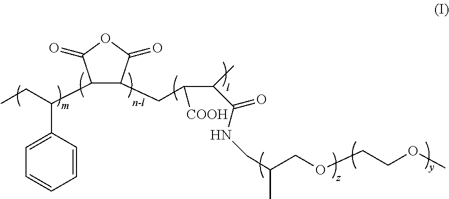

wherein:
m is from about 35 to about 1,200, preferably from about 40 to about 750, and most preferably from about 45 to about 700;
n is the number of moles of maleic anhydride in a reactant used to form the polymer and is from about 2 to about 1200, preferably about 4 to about 750, and most preferably from about 5 to about 300;
l is from about 1 to about 780, preferably about 2 to about 450, and most preferably from about 3 to about 165;
n-l is from about 1 to about 420, preferably about 2 to about 300, and most preferably from about 2 to about 135;
y is from 0 to about 45, preferably about 3 to about 10, and most preferably from about 3 to about 9;
z is from 0 to about 33, preferably about 10 to about 33, and most preferably from about 12 to about 30, provided that one of y or z is at least about 5; and
the ratio of l:n is at most about 0.65:1, preferably at most about 0.6:1, and most preferably at most about 0.55:1.
Aspect 2. The additive composition of Aspect 1, wherein:
the ratio of m:n is between about 1:1 and 25:1; and
the ratio of l:n is between about 1:10 to about 0.65:1, preferably between about 1:4 and 0.6:1.
Aspect 3. The additive composition of Aspect 1 or 2, wherein the ratio of y:z is between about 0 and 1:1.
Aspect 4. The additive composition of any of Aspects 1-3 further comprising an auxiliary agent selected from the group consisting of a fatty acid dimer, a fatty acid, an ester of a fatty acid, and a metal carboxylate salt of a fatty acid, and combinations thereof.
Aspect 5. The additive composition of Aspect 4, wherein the auxiliary agent is the metal carboxylate salt, and the metal is selected from the group consisting of Group I or II metals, preferably zinc, magnesium, or calcium.
Aspect 6. The additive composition of Aspect 4, wherein the auxiliary agent is the fatty acid dimer.
Aspect 7. The additive composition of any of Aspects 4-6, wherein the weight ratio of the polymer to the auxiliary agent is between about 2:1 and about 5:1, preferably between about 5:2 and about 4:1.
Aspect 8. The additive composition of any of Aspects 1-3 further comprising an auxiliary agent selected from the group consisting of zinc stearate, methyl stearate, and castor oil.
Aspect 9. The additive composition of any of Aspects 1-8, wherein m is from about 35 to about 700; n is from about 9 to about 40; l is from about 6 to about 26; n-l is from about 3 to about 34; y is from 0 to about 45; z is from 0 to about 33, provided that one of y or z is at least about 5; and the ratio of l:n is at most about 0.65:1.
Aspect 10. A hot melt adhesive composition comprising:
a base polymer;
an auxiliary polymer having the following structure (I):

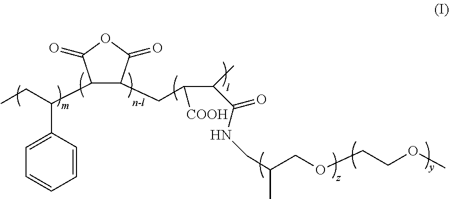

wherein:
   m is from about 35 to about 1,200, preferably from about 40 to about 750, and most preferably from about 45 to about 700;
   n is the number of moles of maleic anhydride in a reactant used to form the polymer and is from about 2 to about 1200, preferably about 4 to about 750, and most preferably from about 5 to about 300;
   l is from about 1 to about 780, preferably about 2 to about 450, and most preferably from about 3 to about 165; and
   n-l from about 1 to about 420, preferably about 2 to about 300, and most preferably from about 2 to about 135;
   y is from 0 to about 45, preferably about 3 to about 10, and most preferably from about 3 to about 9;
   z is from 0 to about 33, preferably about 10 to about 33, and most preferably from about 12 to about 30, provided that one of y or z is at least about 5; and
   the ratio of l:n is at most about 0.65:1, preferably at most about 0.6:1, and most preferably at most about 0.55:1; and
optionally, an auxiliary agent selected from the group consisting of a fatty acid dimer, a fatty acid, an ester of a fatty acid, and a metal carboxylate salt of a fatty acid, and combinations thereof;
optionally, a tackifier; and
optionally, a plasticizer.
Aspect 11. The hot melt adhesive composition of Aspect 10, wherein the base polymer is selected from the group consisting of a styrene block copolymer, polyethylene vinyl acetate (EVA) resins, polyolefins, amorphous poly-α olefin (APAO) resins, and mixtures thereof.
Aspect 12. The hot melt adhesive composition of Aspect 11, wherein the base polymer is the styrene block copolymer and the styrene block copolymer is selected from the group consisting of styrene-isoprene-styrene (SIS), styrene-butadiene-styrene (SBS), styrene-isoprene-butadiene-styrene (SIBS), styrene-ethylene-propylene-styrene (SEPS), styrene-ethylene-butylene-styrene (SEBS) block copolymers, and combinations thereof, preferably SIS.
Aspect 13. The hot melt adhesive composition of any of Aspects 10-12, wherein:
the base polymer is present in an amount of between about 15 wt % and about 50 wt %, preferably between about 25 wt % and about 45 wt %;
the auxiliary polymer is present in an amount of between about 1 wt % and about 15 wt %, preferably between about 2 wt % and about 13 wt %;
the auxiliary agent is present in an amount of between about 0.5 wt % and about 10 wt %, preferably between about 1 wt % and about 5 wt %;
the tackifier is present in an amount of between about 20 wt % and about 60 wt %, preferably between about 30 wt % and about 50 wt %; and
the plasticizer is present in an amount of between about 2 wt % and about 20 wt %, preferably between about 4 wt % and about 15 wt %.
Aspect 14. The hot melt adhesive composition according to claim any of Aspects 10-13 comprising the auxiliary agent, the plasticizer, and the tackifier, wherein the base polymer, the auxiliary polymer, the auxiliary agent, the tackifier, and the plasticizer are present in amounts effective to: (1) provide an average 90° peel strength of mylar-to-glass of at least about 1,000 grams-force, preferably at least about 1,500 grams-force; (2) provide at least 80%, preferably 100%, wash-off from mylar-to-glass; and (3) undergo adhesive failure.
Aspect 15. A method for recycling at least one of a first substrate and a second substrate of a laminate bonded by a hot melt adhesive according to any of Aspects 10-14, wherein the method for recycling comprises the steps of:
contacting the laminate with a recycling solution having a pH sufficient to delaminate the adhesive from at least one of the first substrate and the second substrate; and
retrieving from the recycling solution the at least one of the first substrate and the second substrate free from the adhesive.
Aspect 16. The method of Aspect 15, wherein the recycling solution has a temperature that is at least 20° C. below the crossover temperature of the hot melt adhesive.

### EXAMPLES

The invention is further illustrated by way of the examples which are set forth below.

A variety of synthesized additives were incorporated into hot melt adhesive formulations for facilitating the delamination of adhesives from substrates to allow for less adhesive contamination on substrates to be recycled. The formulations are shown in Table 1 below.

TABLE 1

| | Sample No. | | | | | | | | | |
|---|---|---|---|---|---|---|---|---|---|---|
| | CE1 | CE2 | CE3 | CE4 | Ex 1 | Ex 2 | Ex 3 | Ex 4 | Ex 5 | CE 5 |
| Formulation | US20160186023 Ex 1-4 | | | | Replace ester with amide | | | | Use of TFO | |
| Kraton | 36.2 | 37.5 | 38.9 | 38.9 | 36.2 | 37.5 | 38.9 | 38.9 | 36.2 | 36.2 |
| D1113 | | | | | | | | | | |
| Wingtack | 43.4 | 45 | 46.7 | 46.7 | 43.4 | 45 | 46.7 | 46.7 | 40.4 | 40.4 |
| ET | | | | | | | | | | |
| Nyflex 222B | 7.2 | 7.5 | 7.8 | 7.8 | 7.2 | 7.5 | 7.8 | 7.8 | 7.2 | 7.2 |
| Evernox 10 | 0.9 | 1 | 1 | 1 | 0.9 | 1 | 1 | 1 | 0.9 | 0.9 |
| 1900-144 | 2.46 | 3.64 | 1.14 | 2.28 | 2.46 | 3.64 | 1.14 | 2.28 | 2.46 | 2.46 |
| 1900-135E | 9.84 | 5.46 | 4.56 | 3.42 | | | | | | 9.84 |
| 1900-135D | | | | | 9.84 | 5.46 | 4.56 | 3.42 | 9.84 | |
| Radiacid | | | | | | | | | 3 | 3 |
| 970 | | | | | | | | | | |
| TOTAL (wt %) | 100 | 100.1 | 100.1 | 100.1 | 100 | 100.1 | 100.1 | 100.1 | 100 | 100 |

Wash Off

| | | | | | | | | | | |
|---|---|---|---|---|---|---|---|---|---|---|
| Mylar to | 1 | 1 | 1 | 1 | 2 | 2 | 3 | 1 | 5 | 3 |
| Glass | | | | | | | | | | |
| OPP to | 0 | 0 | 0 | 0 | 0 | 1 | 0 | 1 | 5 | 3 |
| Mylar | | | | | | | | | | |
| Failure | Co | Co | Co | Co | Co/Ad | Ad | Co/Ad | Ad | Ad | Co/Ad |
| Kraft to | 5 | 5 | 5 | 5 | 5 | 5 | 5 | 5 | 5 | 5 |
| Glass | | | | | | | | | | |

The materials used are as follows:
KRATON™ D-1113 is an SIS block copolymer having 16% styrene and 55% diblock and commercially available from Kraton Corporation.
Wingtack® ET is a commercially available C 5 resin from Cray Valley USA LLC.
Nyflex® 222B is a severely hydrotreated naphthenic oil.
Evernox® 10 is a hindered phenolic antioxidant based on pentaerythritol tetrakis (3-(3,5-di-tert-butyl-4-hydroxyphenyl)-propionate and is commercial available from Everspring.
1900-144 is the C5 hydrocarbon polymer comprising a polymeric backbone and, pendent thereon, one or more dicarboxylic acid moieties in at least partial ester form and is made as described above as described in scheme III.
1900-135E is a hydrocarbon copolymer containing one or more dicarboxylic acid moieties in at least partial ester form, commercially available from Cray Valley and described in U.S. Patent Publication No. 2016/0186023.
1900-135D is an auxiliary polymer according to the present invention having the formula shown in structure (IV):

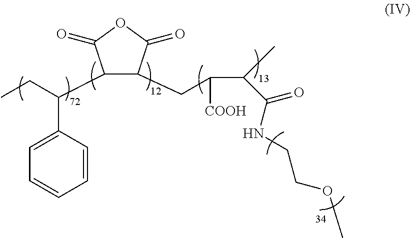

Radiacid 970 is a distilled fatty acid dimer commercially available from Oleon.

The modes of failure are:
Co—cohesive failure of the laminate.
Ad—adhesive failure of the laminate.
Co/Ad or AX—combined adhesive and cohesive failure of the laminates.

To make the above formulations of Comparative Examples 1-5 (CE1 through CE5) and Examples 1-5, all non-polymer ingredients were added to a pint can, which was placed in a heating mantle and set to 177° C. The base polymer, auxiliary polymer, and auxiliary agent (if used) were weighed in separate cups. A nitrogen blanket was placed over the can and impellers were placed into the mixer and a low (12 RPM) speed was set. As temperature reached 177° C., stirring was turned up to 155 RPM. Once at temperature, the base polymer was added slowly with stirring increased to 300 RPM, then the auxiliary polymer and auxiliary agent were added. After 5 minutes of complete addition the stirring was reduced to 150 RPM and further reduced until the mixture was uniform.

To assess the ease of washing off, a wash-off test was run as described above. In summary, a one liter beaker was filled with 2.5% NaOH (aq) to the 800 mL mark. Samples were submerged in the beaker stirring at 350 RPM, at 80° C., for 5 minutes. A scale of 0-5 was given for wash-off: 0 being no wash-off and substrates still firmly adhered together and 5 being that the substrates have completely separated and fallen off during the allotted time. As mentioned above, this zero-to-five scale was equivalent to zero-to-one hundred percent wash-off, with 1 representing about 20% wash-off, 2 representing about 40% wash-off, and so on. As can be seen from Table 1, embodiments of the present invention performed better than the prior art, with Example 5, which also includes the auxiliary agent, performed the best showing complete wash-off and adhesive failure for all laminates tested. The mode of failure herein was the mode of failure upon wash-off, and when the mode of failure was adhesive, it was from Substrate 2.

A peel test was run as described above. Also, DSC analysis (Q-1000) was run as a heat, quench-cool, heat program. Data was taken from the second heating run of 110° C. to 200° C. at 20° C./minute after a consistent heat history was established with the first run from room temperature to 200° C. and quench cool. DMA Temperature scans were run on an ARES rheometer from 140 to −40° C. at 10 rad/sec using 25-mm parallel plates to obtain the Tg and the Tx of the adhesive. The results of these tests are shown below in Table 2.

TABLE 2

| | | Sample No. | | | | | | | | | |
|---|---|---|---|---|---|---|---|---|---|---|---|
| | | CE1 | CE2 | CE3 | CE4 | Ex 1 | Ex 2 | Ex 3 | Ex 4 | Ex 5 | CE5 |
| Formulation | | US20160186023 Ex 1-4 | | | | Replace ester with amide | | | | Use of TFO | |
| DMA | Tg (° C.) | 5.3 | 4.1 | 5.1 | 4.2 | 4.8 | 4.1 | 4 | 4.2 | 1 | 0.7 |
| (Hot to | Txover (° C.) | 113.6 | 112.5 | 114.5 | 113.3 | 108.5 | 110.4 | 111.1 | 111.8 | 108.8 | 108.7 |
| Cold) | | | | | | | | | | | |
| Peel 90° | average (g) | 5348 | 4322 | 4020 | 5351 | 2114 | 2098 | 2405 | 3216 | 253 | 279 |
| to glass | high (g) | 8329 | 5108 | 5550 | 6615 | 2724 | 2602 | 2789 | 3863 | 400.5 | 508 |

As can be seen from the results shown in Table 2, all four examples of the invention (Examples 1-4) showed a reasonable peel force to glass, and even Example 5 retained an average value well above 200 grams-force, which is viable in many applications. In addition, the wash-off performance of the Examples of the invention were, on average, better than those of Comparative Examples 1-4 of the prior art. In addition, an unexpected result was found when comparing Examples 1 and 5 and Comparative Example 5, which is not admitted to be prior art. When comparing those examples, it was unexpected that values of 5 were obtained for all substrates tested and that the mode of failure was found to be adhesive, when neither Example 1 nor Comparative Example 5 had such values or that mode of failure. It has been inferred that there is a synergistic effect when combining the auxiliary polymer and auxiliary agent of the invention. When comparing Example 5 and Comparative Example 5, an increased affinity for wash-off to all substrates is achieved, while Example 5 maintains an acceptable peel strength. This means that the wash-off effect cannot solely be contributed to the decreased peel strength. Table 2 also shows that the Tx of the adhesive remains fairly similar despite the presence of the additive composition, and consistently stays well above the temperature at which wash-off occurs.

Formulations comprising alternatives to Radiacid 970 as the auxiliary agent were prepared and tested for peel strength and wash-off. The constituents were added in the amounts shown below in Table 3 and in the same manner as the above examples.

TABLE 3

| Ex 6 | CE6 | Ex 7 | CE 7 | Ex 8 | CE 8 | |
|---|---|---|---|---|---|---|
| (wt %) | (wt %) | (wt %) | (wt %) | (wt %) | (wt %) | Constituent |
| 36.2 | 36.2 | 36.2 | 36.2 | 36.2 | 36.2 | Kraton |
| | | | | | | D1113 |
| 40.4 | 40.4 | 40.4 | 40.4 | 40.4 | 40.4 | Wingtack ET |
| 7.2 | 7.2 | 7.2 | 7.2 | 7.2 | 7.2 | Nyflex 222B |
| 0.9 | 0.9 | 0.9 | 0.9 | 0.9 | 0.9 | Evernox 10 |
| 2.46 | 2.46 | 2.46 | 2.46 | 2.46 | 2.46 | aliphatic |
| | | | | | | additive |
| | | | | | | (1900-144) |
| | 9.84 | | 9.84 | 9.84 | | aromatic |
| | | | | | | additive |
| | | | | | | (1900-135E) |
| 9.84 | | 9.84 | | | 9.84 | jef. aromatic |
| | | | | | | add. (1900- |
| | | | | | | 135D) |
| 3 | 3 | | | | | Castor Oil |
| | | 3 | 3 | | | Zinc Stearate |
| | | | | 3 | 3 | Methyl |
| | | | | | | Stearate |
| | | | | | | Radiacid 970 |
| 100 | 100 | 100 | 100 | 100 | 100 | TOTAL (wt %) |

The results of testing of the formulations of Table 3 are shown in Table 4 below. Viscosity was measured at 177° C., 163° C., 149° C., and 135° C. (respectively, as viewed from top to bottom in the table) in accordance with ASTM-D3236 by using a Brookfield viscometer. The Ring and Ball softening points (“RBSP” in Table 4) were measured by ASTM E28 in glycerol with an automated Herzog unit. The wash-off and peel strength tests were the same as described above. AX stands for combined adhesive and cohesive failure of the laminates.

The wash-off and peel strength tests confirm the clear differences in amide versus ester linkages and the improved effect caused by the addition of auxiliary agents such as castor oil, zinc stearate, and methyl stearate. The combination of the amide linkage and the auxiliary agents described herein noticeably improves wash-off without adversely impacting the adhesives' peel strength values.

TABLE 4

| Ex 6 | CE6 | Ex 7 | CE7 | CE8 | Ex 8 | Sample No. |
|---|---|---|---|---|---|---|
| Castor/ | Castor | Zn Stear/ | Zn Stear | Stearic | Stearic | Description |
| Jeff | | Jeff | | Acid | Acid/Jeff | |
| 14600 | 23800 | 15050 | 16175 | 12250 | 8650 | Viscosity |
| 29000 | 51000 | 29900 | 34000 | 22100 | 15050 | at T (° C.)= |
| 76500 | 138000 | 80000 | 93500 | 52200 | 33200 | |
| 265000 | 487000 | 270000 | 333000 | 164000 | 94500 | |
| Amide | Ester | Amide | Ester | Ester | Amide | |
| 235.35 | 240.45 | 232.05 | 231.2 | 227.4 | 220.85 | RBSP (° F.) |
| 100 | 0 | 100 | 80 | 20 | 80 | Wash Off % |
| | | | | | | (Mylar to |
| | | | | | | Glass) |
| 100 | 0 | 100 | 0 | 0 | 80 | Wash Off % |
| | | | | | | (OPP to |
| | | | | | | Mylar) |
| 1812 | 3873 | 1559 | 2489 | 1996 | 1846 | Avg Peel, g- |
| | | | | | | force |
| 2377 | 4469 | 2206 | 3200 | 2572 | 2196 | High Peel, g- |
| | | | | | | force |
| AX | AF | AF/CF | AF | AX | AX | Fail Mode |

Additional formulations of hot melt adhesives were made using the in situ method, in which the auxiliary agent and the reactants used to make the auxiliary polymer were added to various constituents of the hot melt adhesive as the latter was being made. The reactants and constituents were added in the amounts shown below in Table 5.

TABLE 5

| | | Sample No. |
|---|---|---|
| | | Ex 9 |
| Formulation | Constituent | Amount (wt %) or Value |
| | Kraton D1113 | 36.2 |
| | Wingtack ET | 40.4 |
| | Nyflex 222B | 7.2 |
| | Evernox 10 | 0.9 |
| | Jeffamine M2005 | 3.69 |
| | Xiran 3000 | 8.61 |
| | Castor Oil | 3 |
| | TOTAL (wt %) | 100 |
| Viscosity at | 177 | 16570 |
| T (° C.)= | 163 | 32400 |
| | 149 | 83000 |
| | 135 | 279000 |
| Peel (90 deg) | mylar to glass, avg, | 1069 |
| | gf | |
| Peel (90 deg) | Mylar to glass, high, | 1570 |
| | gf | |
| Wash Off (%) | Mylar to glass | 5 |
| Wash Off (%) | Mylar to OPP | 60 |
| Failure Mode | For wash off | Adhesive |

Xiran 3000 was added to a one-quart, Teledyne Readco kneader at 177° C. and mixed until melted. The base polymer (Kraton D1113) was added and mixed until homogenous. The mono-functional polyether amine (Jeffamine M-2005), plasticizer (Nyflex 222B), tackifier (Wingtack ET), and anti-oxidant (Evernox 10) were added and mixed for a minimum of one hour, or until well-mixed. Finally, the auxiliary additive (castor oil) was added to the kneader and mixed for 30 minutes. The formulated adhesive was then poured out and the peel and wash-off properties were evaluated. As can be seen, Table 5 reveals that adhesive made using the in situ method (i.e., Example 9) retained good 90° peel strength and good wash-off, even on difficult substrates like Mylar® to OPP. Also, the mode of failure was adhesive, which is generally preferred.

In order to attempt to discern the mechanism of action resulting in the effects of the present invention, the relative solubility of an amide-linked versus an ester-linked polymer was assessed. Both 1900-135E and 1900-135D were separately added in an amount of 10 wt % to pure water, a 1% NaOH caustic wash, and a 5% NaOH caustic wash. After one hour, a clear difference in solubility was shown, with 135E being soluble in pure water and 1% NaOH, but not 5% NaOH, whereas 135A was insoluble in all three media. It may be inferred, without being bound to any hypothesis, that the harder-to-solubilize amide linked polymers allow for “pulling” of the adhesive off of substrates when subjected to wash-off conditions, whereas easier-to-solubilize ester-linked polymers cause dissolving the additive out of the adhesive matrix and therefore seeing no wash-off effect.

Additional formulations as Examples 10 and Comparative Examples 9-12 were prepared and tested in the same manner as Examples 1-5 using an auxiliary polymer (identified as AP (I) in Table 6 below) having the formula shown in structure (I) with different ratios of the number of moles of amide-linked polyether that are formed (1) to the number of number of moles of maleic anhydride (n) in the reactant. In particular, the ratio of l:n for Example 10 was 0.52:1. On the other hand, the ratio of l:n for Comparative Examples 9-12 were all at least 1:1 (i.e., all of the maleic anhydride was reacted to form the amide-linked polyether). Therefore, the auxiliary polymer used in Comparative Examples 9-12 had no unreacted maleic anhydride and more of the amide-linked polyether than that of Example 10. The constituents of Example 10 and Comparative Examples 9-12, including the l:n value, are shown in Table 6.

TABLE 6

| Ex 10 | CE 9 | CE 10 | CE 11 | CW 12 | |
|---|---|---|---|---|---|
| 37.4 | 37.4 | 37.4 | 37.4 | 37.4 | Kraton D1113 |
| 41.7 | 41.7 | 41.7 | 41.7 | 41.7 | Wingtack ET |
| 7.2 | 7.2 | 7.2 | 7.2 | 7.2 | Nyflex 228B |
| 0.9 | 0.9 | 0.9 | 0.9 | 0.9 | Evernox 10 |
| 9.8 | | | | | A.P. (I) (l:n = 0.52:1) |
| | 9.8 | | | | A.P. (I) (l:n is at least 1:1) |
| | | 9.8 | | | A.P. (I) (l:n is at least 1:1) |
| | | | 9.8 | | A.P. (I) ((l:n is at least 1:1) |
| | | | | 9.8 | A.P. (I) (l:n is at least 1:1) |
| 3 | 3 | 3 | 3 | 3 | Castor Oil |
| 100 | 100 | 100 | 100 | 100 | TOTAL (wt %) |
| | | | | | Viscosity at T (° C.)= |
| 15270 | 13725 | 15300 | 15425 | 15470 | 177 |
| 30100 | 25050 | 29900 | 31000 | 30500 | 163 |
| 76870 | 61125 | 75750 | 80000 | 75500 | 149 |
| 255000 | 196000 | 254000 | 263000 | 248500 | 135 |
| 50% | 0% | 20% | 0% | 0% | Wash Off (OPP to Mylar) |

As demonstrated above, Example 10 performed better than Comparative Examples 9-12, showing the importance of having an l:n molar ratio of at most 0.65:1, preferably at most 0.6:1, and most preferably at most 0.55:1. It should be noted that a particular wash-off percentage (50% in this case) or rating should not be deemed a failure. Wash-off performance depends on a number of factors such as wash-off time and temperature, the basicity of the caustic used, and the extent of agitation during wash-off. The results of Table 6 show that, with all else being constant, an auxiliary polymer of the present invention shows noticeable improvement in wash-off performance over the prior art.

Table 7 below shows that Example 9 showed comparable peel strength relative to Comparative Examples 9-12. Example 9 also underwent adhesive failure, the preferred mode of failure.

| Ex 10 | CE 9 | CE 10 | CE 11 | CW 12 | |
|---|---|---|---|---|---|
| 1670 | 2064 | 1617 | 2651 | 874 | Peel (90°) mylar to glass |
| 2120 | 2593 | 1912 | 3377 | 1167 | |
| A | A | A | A | A/AX | |

Where a range of values is provided, it is understood that each intervening value, and any combination or sub-combination of intervening values, between the upper and lower limit of that range and any other stated or intervening value in that stated range, is encompassed within the range of values recited. In addition, the invention includes a range of a constituent which is the lower limit of a first range and an upper limit of a second range of that constituent.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue or prior invention.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. An additive composition for facilitating delamination of a hot melt adhesive from a substrate, comprising a polymer having the following structure (I): 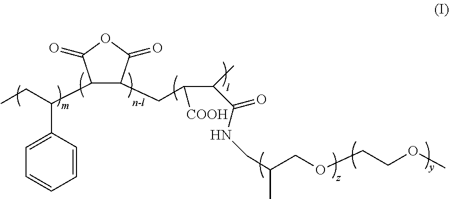
wherein:
m is from about 35 to about 1,200;
n is the number of moles of maleic anhydride in a reactant used to form the polymer and is from about 2 to about 1200;
l is from about 1 to about 780;
n-l is from about 1 to about 420;
y is from 0 to about 45;
z is from 0 to about 33, provided that one of y or z is at least about 5; and
the ratio of l:n is at most about 0.65:1.

2. The additive composition of claim 1, wherein:
the ratio of min is between about 1:1 and 25:1; and
the ratio of l:n is between about 1:10 to about 0.65:1.

3. The additive composition of claim 1, wherein the ratio of y:z is between about 0 and 1:1.

4. The additive composition of claim 1 further comprising an auxiliary agent selected from the group consisting of a fatty acid dimer, a fatty acid, an ester of a fatty acid, and a metal carboxylate salt of a fatty acid, and combinations thereof.

5. The additive composition of claim 4, wherein the auxiliary agent is the metal carboxylate salt, and the metal is selected from the group consisting of Group I or II metals, preferably zinc, magnesium, or calcium.

6. The additive composition of claim 4, wherein the auxiliary agent is the fatty acid dimer.

7. The additive composition of claim 4, wherein the weight ratio of the polymer to the auxiliary agent is between about 2:1 and about 5:1.

8. The additive composition of claim 1 further comprising an auxiliary agent selected from the group consisting of zinc stearate, methyl stearate, and castor oil.

9. A hot melt adhesive composition comprising:
a base polymer;
an auxiliary polymer having the following structure (I): 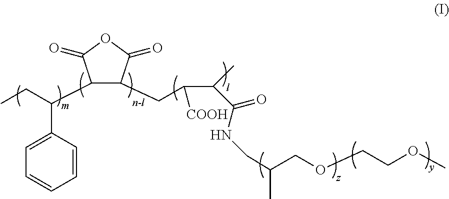
wherein:
m is from about 35 to about 1,200;
n is the number of moles of maleic anhydride in a reactant used to form the polymer and is from about 2 to about 1200;
l is from about 1 to about 780; and
n-l is from about 1 to about 420;
y is from 0 to about 45;
z is from 0 to about 33, provided that one of y or z is at least about 5; and
the ratio of l:n is at most about 0.65:1.
optionally, an auxiliary agent selected from the group consisting of a fatty acid dimer, a fatty acid, an ester of a fatty acid, and a metal carboxylate salt of a fatty acid, and combinations thereof;
optionally, a tackifier; and
optionally, a plasticizer.

10. The hot melt adhesive composition of claim 9, wherein the base polymer is selected from the group consisting of a styrene block copolymer, polyethylene vinyl acetate (EVA) resins, polyolefins, amorphous poly-α olefin (APAO) resins, and mixtures thereof.

11. The hot melt adhesive composition of claim 10, wherein the base polymer is the styrene block copolymer and the styrene block copolymer is selected from the group consisting of styrene-isoprene-styrene (SIS), styrene-butadiene-styrene (SBS), styrene-isoprene-butadiene-styrene (SIBS), styrene-ethylene-propylene-styrene (SEPS), styrene-ethylene-butylene-styrene (SEBS) block copolymers, and combinations thereof.

12. The hot melt adhesive composition of claim 9, wherein:
the base polymer is present in an amount of between about 15 wt % and about 50 wt %;
the auxiliary polymer is present in an amount of between about 1 wt % and about 15 wt %;
the auxiliary agent is present in an amount of between about 0.5 wt % and about 10 wt %;
the tackifier is present in an amount of between about 20 wt % and about 60 wt %; and
the plasticizer is present in an amount of between about 2 wt % and about 20 wt %.

13. The hot melt adhesive composition according to claim 9 comprising the auxiliary agent, the plasticizer, and the tackifier, wherein the base polymer, the auxiliary polymer, the auxiliary agent, the tackifier, and the plasticizer are present in amounts effective to: (1) provide an average 90° peel strength of mylar-to-glass of at least about 1,000 grams-force; (2) provide at least 80% wash-off from mylar-to-glass; and (3) undergo adhesive failure.

14. A method for recycling at least one of a first substrate and a second substrate of a laminate bonded by a hot melt adhesive according to claim 9, wherein the method for recycling comprises the steps of:
contacting the laminate with a recycling solution having a pH sufficient to delaminate the adhesive from at least one of the first substrate and the second substrate; and
retrieving from the recycling solution the at least one of the first substrate and the second substrate free from the adhesive.

15. The method of claim 14, wherein the recycling solution has a temperature that is at least 20° C. below the crossover temperature of the hot melt adhesive.

16. The additive composition of claim 1, wherein:
m is from about 40 to about 750;
n is from about 4 to about 750;
l is from about 2 to about 450;
n-l is from about 2 to about 300;
y is from 3 to about 10;
z is from 10 to about 33; and
the ratio of l:n is at most about 0.6:1.

17. The additive composition of claim 1, wherein:
m is from about 45 to about 700;
n is from about 5 to about 300;
l is from about 3 to about 165;
n-l is from about 2 to about 135;
y is from 3 to about 9;
z is from 12 to about 30; and
the ratio of l:n is at most about 0.55:1.

18. The hot melt adhesive composition of claim 9, wherein:
m is from about 40 to about 750;
n is from about 4 to about 750;
l is from about 2 to about 450;
n-l is from about 2 to about 300;
y is from 3 to about 10;
z is from 10 to about 33; and
the ratio of l:n is at most about 0.6:1.

19. The hot melt adhesive composition of claim 9, wherein:
m is from about 45 to about 700;
n is from about 5 to about 300;
l is from about 3 to about 165;
n-l is from about 2 to about 135;
y is from 3 to about 9;
z is from 12 to about 30; and
the ratio of l:n is at most about 0.55:1.

20. The hot melt adhesive composition of claim 12, wherein:
the base polymer is present in an amount of between about 25 wt % and about 45 wt %;
the auxiliary polymer is present in an amount of between about 2 wt % and about 13 wt %;
the auxiliary agent is present in an amount of between about 1 wt % and about 5 wt %;
the tackifier is present in an amount of between about 30 wt % and about 50 wt %; and
the plasticizer is present in an amount of between about 4 wt % and about 15 wt %.
